(19) United States
(12) Patent Application Publication
(10) Pub. No.: US 2011/0145876 A1
(43) Pub. Date: Jun. 16, 2011

(54) APPARATUS FOR PURCHASE AND DELIVERY OF ENTITLEMENT, METHOD THEREOF, AND SETTOP BOX IN IPTV BROADCAST SYSTEM

(75) Inventors: Moon-Ok CHOI, Cheongju-si (KR); Shin-Yuk Kang, Daejeon (KR); Tae-In Hwang, Daejeon (KR); Jong-Youl Park, Daejeon (KR); Jin-Young Moon, Daejeon (KR); Eui-Hyun Paik, Daejeon (KR)

(73) Assignee: Electronics and Telecommunications Research Institute, Daejeon (KR)

(21) Appl. No.: 12/963,939

(22) Filed: Dec. 9, 2010

(30) Foreign Application Priority Data
Dec. 16, 2009 (KR) 10-2009-0125442

(51) Int. Cl. H04N 7/173

(52) U.S. Cl. 725/110

(57) ABSTRACT

Disclosed is an apparatus for purchase and delivery of entitlement in an IPTV broadcast system according to an embodiment of the present invention that includes: an entitlement purchase environment provider providing a charged broadcast contents list to the purchaser so that the purchaser can select delivery target contents and providing an IPTV broadcasting service subscriber list to the purchaser so that the purchaser can select one or more entitlement delivery target subscribers to which the entitlement for the delivery target contents is delivered; an entitlement generator receiving information on the delivery target contents from the entitlement purchase environment provider, and then generating the entitlement for corresponding broadcast contents; and an entitlement transmitter delivering the entitlement for the delivery target contents to IPTV settop boxes of the entitlement delivery target subscribers on the basis of information on the entitlement delivery target subscribers.

### RELATED APPLICATIONS

The present application claims priority to Korean Patent Application Number 10-2009-0125442, filed on Dec. 16, 2009, the entirety of which is hereby incorporated by reference.

### BACKGROUND OF THE INVENTION

1. Field of the Invention

The present invention relates to an apparatus for purchase and delivery of entitlement, a method thereof, and a settop box in an IPTV broadcast system. More particularly, an apparatus that allows a predetermined IPTV service subscriber or a predetermined non-subscriber to purchase the entitlement for broadcast contents corresponding to a predetermined program or channel and deliver the entitlement to another predetermined IPTV service subscriber in an IPTV broadcast system adopting a downloadable conditional access system (DCAS) and a method thereof.

2. Description of the Related Art

With the rapid development of a broadcasting technology, a broadcasting environment has diversified and in recent years, an Internet protocol television (IPTV) technology based on the Internet has been developed and commercialized.

The IPTV technology provides an interactive television broadcasting service through high-speed Internet. By connecting a contents server with a display apparatus via a settop box that is interfaced between the Internet and the display apparatus, the contents server provides an information contents service, a moving picture contents service, a broadcasting contents service, etc., to a user through the display apparatus connected to the settop box.

Therefore, the user watches a real-time broadcasting stream or a requested VOD transmitted from the contents server through the TV by using the settop box.

In general, IPTV broadcast service providers transmit broadcast contents as MPEG2-TS by adopting a cable or terrestrial broadcasting standard. For this, an IPTV service providing system includes a headend system including a scrambling apparatus, a multiplexing apparatus, a broadcast conditional access apparatus, and a broadcast transmitting apparatus and a resource-limited settop box for playing the MPEG2-TS received from the headend system.

Meanwhile, the IPTV broadcast service providers need a system capable of charging a contents service fee to a subscriber and controlling the use of the contents in order to stably provide a high-quality content service. Technologies that transmit encrypted contents and allow only subscribers having a usage right for the corresponding contents to decode contents and thereafter, use them are generally adopted in order for only users having an authorized usage right to use charged contents.

One of the technologies includes a conditional access system (CAS).

The conditional access system (CAS) means a security system for broadcast contents that allows only a subscriber who purchases entitlement through a legal purchase procedure to watch a predetermined channel or program in DMB, cable broadcasting, or IPTV broadcasting service.

For this, the known conditional access system encrypts (scrambles) broadcast contents corresponding to a predetermined charged channel or program and delivers them to a user, and delivers entitlement to a settop box of a subscriber who purchases the corresponding broadcast contents to enable only a subscriber having the entitlement to decode (descrambles) the corresponding broadcast contents and watch them. The entitlement may be called, in other words, a watching entitlement, a watching authority, and a reception authority.

Meanwhile, in the downloadable conditional access system (DCAS), the above-mentioned conditional access system is not previously installed in the settop box, but the conditional access system is installed and driven in a replacement or upgrade form by accessing a DCAS server online through network connection and downloading a CAS module. In addition, the DCAS provides a security system that enables watching broadcast contents decodable by the corresponding CAS module.

The DCAS has an open structure which is replaceable and upgradeable on-line to provide a more flexible environment to a broadcast provider, a CAS provider, and a service provider than a CAS that is fixedly installed in the existing settop box in advance.

However, the known IPTV-based broadcasting service adopting the downloadable conditional access system (DCAS) cannot provide a method that enables a predetermined IPTV broadcasting service subscriber or a predetermined non-subscriber to purchase the entitlement for predetermined charged broadcast contents corresponding to real-time broadcast contents or VOD contents and deliver the CAS module and purchase information to another predetermined IPTV broadcasting service subscriber.

### SUMMARY OF THE INVENTION

The present invention is contrived to solve the above-mentioned problems, there is an object of the present invention to provide an apparatus that enables a predetermined IPTV broadcasting service subscriber or a predetermined non-subscriber to purchase the entitlement for predetermined charged broadcast contents corresponding to real-time broadcast contents or VOD contents and deliver the CAS module and purchase information to another predetermined IPTV broadcasting service subscriber to enable the corresponding IPTV broadcasting service subscriber to watch the corresponding broadcast contents in an IPTV-based broadcasting service adopting the downloadable conditional access system (DCAS) and a method thereof.

In particular, there is another object of the present invention to provide a method that can provide to an IPTV broadcasting service provider a purchase environment which enables a purchaser to purchase the entitlement for predetermined broadcast contents and safely deliver a CAS module and purchase information related to the corresponding broadcast contents to an IPTV broadcasting service subscriber terminal which is a service target of the entitlement purchased by the purchaser.

In addition, there is yet another object of the present invention to provide a method that enables the IPTV broadcasting service subscriber to verify an entitlement scope and purchaser information by using the delivered purchase information and to watch the corresponding broadcast contents through a safe method adopting a security by driving the delivered CAS module.

In order to achieve the above objects, according to an exemplary embodiment of the present invention, there is provided an apparatus for purchase and delivery of entitlement in an IPTV broadcast system that includes: an entitlement purchase environment provider providing a charged broadcast contents list to the purchaser so that the purchaser can select delivery target contents and providing an IPTV broadcasting service subscriber list to the purchaser so that the purchaser can select one or more entitlement delivery target subscribers to which the entitlement for the delivery target contents is delivered; an entitlement generator receiving information on the delivery target contents from the entitlement purchase environment provider, and then generating the entitlement for corresponding broadcast contents; and an entitlement transmitter delivering the entitlement for the delivery target contents to IPTV settop boxes of the entitlement delivery target subscribers on the basis of information on the entitlement delivery target subscribers.

In particular, the entitlement purchase environment provider further receives at least one received information of a receivable period, a receivable number of times, an entitlement scope, and a delivery message of the delivery target contents from the purchaser, and the entitlement generator generates purchase information on the basis the received information to process the purchase information to be delivered to the IPTV settop box of the delivery target subscriber in addition to the entitlement for the delivery target contents.

Further, the purchaser is an IPTV broadcasting service subscriber or an IPTV broadcasting service non-subscriber.

The entitlement generator generates the purchase information by using information on an corresponding IPTV broadcasting service subscriber stored in an IPTV subscriber database and the received information when the purchaser is an IPTV broadcasting service subscriber.

The entitlement transmitter delivers the entitlement for the delivery target contents to the IPTV settop boxes of the entitlement delivery target subscribers by using an out of band (OOB) channel.

The entitlement purchase environment provider uses at least one of an e-mail address, a telephone number, an ID, and a nickname of an IPTV broadcasting service subscriber stored in an IPTV subscriber database at the time of providing the IPTV broadcasting service subscriber list to the purchaser.

The entitlement includes a CAS module for decoding a corresponding broadcast contents stream.

The CAS module processes an entitlement management message (EMM) and an entitlement control message (ECM) transmitted by being included in the corresponding broadcast contents stream.

According to another embodiment of the present invention, there is provided an IPTV settop box in an IPTV broadcast system that includes: an entitlement purchase processor providing a user interface for allowing a purchaser to select a delivery target contents and one or more entitlement delivery target subscribers to which an entitlement for the delivery target contents is delivered; and an entitlement receiver receiving the entitlement for predetermined broadcast contents purchased by a predetermined purchaser from a headend system.

In particular, the entitlement receiver further receives purchase information including at least one received information of a receivable period, a receivable number of times, an entitlement scope, and a delivery message of the predetermined broadcast contents from the headend system.

The entitlement includes a CAS module for decoding a predetermined broadcast contents stream.

According to yet another embodiment of the present invention, there is provided a method for purchase and delivery of entitlement in an IPTV broadcast system that includes: selecting delivery target contents by providing a charged broadcast contents list to a purchaser; selecting one or more entitlement delivery target subscribers to which the entitlement for the delivery target contents is delivered by providing an IPTV broadcasting service subscriber list to the purchaser; generating the entitlement for the delivery target contents; and delivering the entitlement for the delivery target contents to IPTV settop boxes of the entitlement delivery target subscribers on the basis of information on the entitlement delivery target subscribers.

In particular, the method further includes: further receiving at least one received information of a receivable period, a receivable number of times, an entitlement scope, and a delivery message of the delivery target contents from the purchaser; and generating purchase information on the basis the received information to process the purchase information to be delivered to the IPTV settop boxes of the delivery target subscribers in addition to the entitlement for the delivery target contents.

The generating of the purchase information on the basis the received information generates the purchase information by using information on an corresponding IPTV broadcasting service subscriber stored in an IPTV subscriber database and the received information when the purchaser is the IPTV broadcasting service subscriber.

The delivering of the entitlement for the delivery target contents to the IPTV settop boxes of the entitlement delivery target subscribers delivers the entitlement for the delivery target contents to the IPTV settop box of the entitlement delivery target subscribers by using an out of band (OOB) channel.

The providing of the charged broadcast contents list to the purchaser uses at least one of an e-mail address, a telephone number, an ID, and a nickname of an IPTV broadcasting service subscriber stored in an IPTV subscriber database at the time of providing the IPTV broadcasting service subscriber list to the purchaser.

The entitlement includes a CAS module for decoding a corresponding broadcast contents stream.

The CAS module processes an entitlement management message (EMM) and an entitlement control message (ECM) transmitted by being included in the corresponding broadcast contents stream.

The method further includes processing a payment according to a entitlement purchase when the entitlement is successfully delivered to the IPTV settop boxes of the entitlement delivery target subscribers.

According to the exemplary embodiments of the present invention, the following effects can be acquired.

An IPTV-based broadcasting service adopting the downloadable conditional access system (DCAS) enables a predetermined IPTV broadcasting service subscriber or a predetermined non-subscriber to purchase the entitlement for predetermined charged broadcast contents corresponding to real-time broadcast contents or VOD contents and deliver the CAS module and purchase information to another predetermined IPTV broadcasting service subscriber so as to enable the corresponding IPTV broadcasting service subscriber to verify the entitlement for the predetermined delivered broadcast contents and watch the corresponding broadcast contents.

Further, since the system is driven not by directly delivering a decoding key of the corresponding broadcast contents but by delivering a CAS module capable of processing a decoding function, the system is safe in terms of security while the entitlement for the broadcast contents is delivered to the IPTV broadcasting service subscriber.

Accordingly, since the entitlement is purchased by an entitlement purchaser in addition to a voluntary service subscriber, purchasing of the IPTV broadcast contents are activated for an IPTV broadcasting service provider. Further, when the system, as a promotional means of an enterprise, is utilized as methods of providing the entitlement to a predetermined group which is a promotional target, inserting a predetermined enterprise advertisement into the corresponding broadcast contents, etc., the system can promote purchasing of the IPTV broadcast contents and increase a promotional effect of the corresponding enterprise.

In addition, the IPTV broadcasting service subscriber can acquire a change to watch broadcast contents other than the broadcast contents purchased by himself/herself and share predetermined broadcast contents preferred by a service user (purchaser) with another IPTV broadcasting service subscriber in a safe and legal method.

### BRIEF DESCRIPTION OF THE DRAWINGS

FIG. 1 is a diagram for describing an IPTV broadcast system according to an exemplary embodiment of the present invention;

FIG. 2 is a diagram for describing a method for purchase and delivery of entitlement in terms of an IPTV broadcasting service provider;

FIG. 3 is a diagram for describing a method for purchasing entitlement according to an exemplary embodiment of the present invention; and

FIG. 4 is a diagram for describing a method for receiving entitlement according to an exemplary embodiment of the present invention.

### DETAILED DESCRIPTION OF THE PREFERRED EMBODIMENTS

Exemplary embodiments of the present invention will be described below with reference to the accompanying drawings. Herein, the detailed description of a known function and configuration that may make the purpose of the present invention unnecessarily ambiguous in describing the spirit of the present invention will be omitted. Exemplary embodiments of the present invention are provided so that those skilled in the art may more completely understand the present invention. Accordingly, the shape, the size, etc., of elements in the figures may be exaggerated for a more clear description.

First, the present invention provides a method for generating and delivering a CAS module and purchase information that enables an IPTV broadcasting service provider to provide a list of charged broadcast contents to a purchaser and provide an environment capable of purchasing the entitlement for predetermined broadcast contents from the corresponding list and enables a predetermined IPTV broadcasting service subscriber retrieved or selected by the purchaser to watch the corresponding broadcast contents.

Further, the present invention provides a method for an IPTV broadcasting service subscriber to watch the corresponding broadcast contents in a safe method adopting security by receiving, installing, and driving the CAS module delivered through such a method.

Further, the present invention provides a method for an IPTV broadcasting service subscriber or a non-subscriber to purchase the entitlement for the predetermined broadcast contents from the charged broadcast contents list provided by the corresponding IPTV broadcasting service and deliver the CAS module and purchase information to the predetermined IPTV broadcasting service subscriber.

Hereinafter, exemplary embodiments of the present invention will be described in detail with reference to the accompanying drawings.

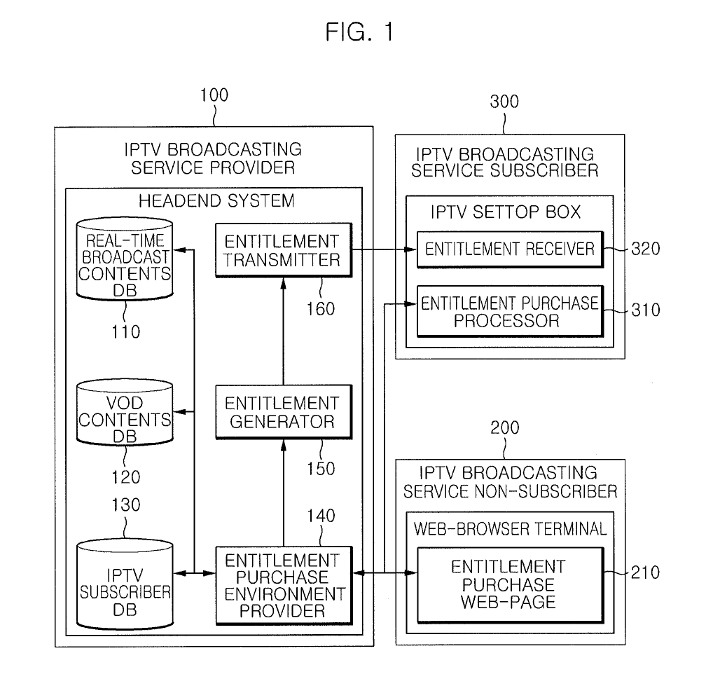

FIG. 1 is a diagram for describing an IPTV broadcast system according to an exemplary embodiment of the present invention.

Referring to FIG. 1, the IPTV broadcast system according to the exemplary embodiment of the present invention includes a headend system at an IPTV broadcasting service provider 100, a web-browser terminal at an IPTV broadcasting service non-subscriber 200, and an IPTV settop box at an IPTV broadcasting service subscriber 300.

The headend system according to the exemplary embodiment of the present invention includes a real-time broadcast contents database 110, a VOD contents database 120, an IPTV subscriber database 130, etc., which are necessary to provide an IPTV broadcasting service. Further, the headend system according to the exemplary embodiment of the present invention further includes an entitlement purchasing and delivering apparatus including an entitlement purchase environment provider 140, an entitlement generator 150, and an entitlement transmitter 160.

The real-time broadcast contents database (hereinafter, referred to as ‘real-time broadcast contents DB’) 110 and the VOD contents database (hereinafter, referred to as ‘VOD contents DB’) 120 store real-time broadcast contents and VOD contents for the IPTV broadcasting service subscriber, respectively.

The IPTV subscriber database (hereinafter, referred to as ‘IPTV subscriber DB’) 130 stores information on the subscriber who subscribes to the IPTV broadcasting service. The information may include a name, a nickname, a telephone number, an ID, an e-mail address, a resident registration number, a residence address, etc., of the subscriber.

The entitlement purchase environment provider 140 configures a charged broadcast contents list by using charged broadcast contents stored in the real-time broadcast contents DB 110 and the VOD contents DB 120 and provides it to a purchaser, which selects delivery target contents. In addition, one or more entitlement delivery target subscribers to which the delivery target contents will be delivered are selected by providing an IPTV broadcasting service subscriber list to the purchaser.

More specifically, the entitlement purchase environment provider 140 configures the charged broadcast contents (real-time broadcast or VOD contents) list in link with the real-time broadcast contents DB 110 or the VOD contents DB 120 and provides the corresponding list to the purchaser to provide an environment capable of selecting broadcast contents to be purchased.

Further, the entitlement purchase environment provider 140 provides an environment in which the purchaser can input a receivable period, a receivable number of times, an entitlement scope, and a delivery message for the delivery target contents.

In addition, the entitlement purchase environment provider 140 provides the IPTV broadcasting service subscriber list (IPTV subscriber list) or a subscriber retrieving method to the purchaser in link with the IPTV subscriber DB 130 and provides an environment in which a target IPTV subscriber (entitlement delivery target subscriber) to which the entitlement for the delivery target contents selected by the purchaser will be delivered can be selected from the corresponding IPTV subscriber list. Meanwhile, the entitlement purchase environment provider 140 may use the e-mail address, telephone number, ID, nickname, etc., of the IPTV broadcasting service subscriber stored in the IPTV subscriber DB 130 at the time of providing the IPTV subscriber list or the subscriber retrieving method to the purchaser. In this case, it is preferable to adopt a policy capable of solving a problem of leaking personal information.

Further, the entitlement purchase environment provider 140 provides a simple message input environment by the purchaser and in the case of succeeding in delivering the entitlement to the entitlement delivery target subscriber, the entitlement purchase environment provider 140 takes charge of a payment processing function for purchasing.

The entitlement generator 150 receives the information on the delivery target contents from the entitlement purchase environment provider 140 and generates the entitlement for the corresponding broadcast contents.

More specifically, the entitlement generator 150 receives the information on the delivery target contents, the information on the entitlement delivery target subscriber, and the purchase information delivered from the entitlement purchase environment provider 140 and prepares for the CAS module related to decoding the corresponding broadcast contents.

The CAS module may be installed and driven in the IPTV broadcasting service system adopting the downloadable conditional access system (DCAS) and processes an entitlement management message (EMM) and an entitlement control message (ECM) delivered by being included in an MPEG2-TS type stream and decodes (descrambles) the corresponding broadcast contents stream.

Further, the entitlement generator 150 generates the purchase information on the basis of the receivable period, the receivable number of times, the entitlement scope, and the delivery message for the delivery target contents inputted by the purchaser in the entitlement purchase environment provider 140.

In this case, when the purchaser is the IPTV broadcasting service subscriber 300, the entitlement generator 150 preferably generates the purchase information by using information on the corresponding IPTV broadcasting service subscriber and the information (the entitlement scope and the delivery message) received from the entitlement purchase environment provider 140.

On the contrary, when the purchaser is an IPTV broadcasting service non-subscriber 200, the entitlement generator 150 preferably generates the purchase information by using only the information received form the entitlement purchase environment provider 140.

The entitlement transmitter 160 receives the CAS module and the purchase information prepared in the entitlement generator 150 and the entitlement delivery target subscriber information and delivers them to an IPTV settop box of the corresponding entitlement delivery target subscriber. Since the data delivered at that time is information effective to only the corresponding IPTV broadcasting service subscriber, the data is preferably transmitted by using an out of band (OOB) channel.

In the embodiment of the present invention, since the system is driven not by directly transferring a decoding key of the corresponding broadcast contents but by transferring a CAS module capable of processing a decoding function, the system is safe in terms of the security while the entitlement for the broadcast contents is transferred to the IPTV broadcasting service subscriber.

A web-browser terminal of the IPTV broadcasting service non-subscriber 200 enables purchasing through a purchasing screen provided in a web-page format by using a general terminal (i.e., a PC) with a web-browser by considering a case in which the IPTV broadcasting service non-subscriber 200 purchases the broadcast contents.

The IPTV settop box of the IPTV broadcasting service subscriber 300 is provided with an entitlement purchase processor 310 and an entitlement receiver 320 in addition to a general IPTV settop box function required to receive the IPTV broadcasting service adopting the downloadable conditional access system (DCAS).

The entitlement purchase processor 310 provides a user interface for selecting delivery target contents and one or more entitlement delivery target subscribers from the purchaser to which the entitlement for the delivery target contents will be delivered.

More specifically, the entitlement purchase processor 310 provides the entitlement purchase environment provided from the entitlement purchase environment provider 140 of the IPTV broadcasting service provider 100 to a screen output device connected with the IPTV settop box or in an Internet web-page format.

Further, the entitlement purchase processor 310 takes charge of the processing selection of the broadcast contents by the purchaser, selection of the entitlement delivery target subscriber, and a predetermined purchase information input processing function and takes charge of the payment processing function for purchasing the entitlement.

The entitlement receiver 320 receives the entitlement for predetermined broadcast contents purchased by a predetermined purchaser from the headend system and processes the corresponding IPTV broadcasting service subscriber to watch the predetermined contents by using the entitlement received by the corresponding IPTV broadcasting service subscriber.

More specifically, the entitlement receiver 320 receives a CAS module and purchase information related to the entitlement purchased and delivered by the predetermined purchaser and outputs the corresponding subscriber information, and outputs the entitlement scope from the received purchase information and a simple delivery message inputted by the purchaser, and outputs the corresponding subscriber information when the purchaser is the IPTV broadcasting service subscriber 300.

According to the configuration of the present invention described above, the IPTV-based broadcasting service adopting the downloadable conditional access system (DCAS) enables a predetermined IPTV broadcasting service subscriber or a predetermined non-subscriber to purchase the entitlement for predetermined charged broadcast contents corresponding real-time broadcast contents or VOD contents and deliver the CAS module and purchase information to another predetermined IPTV broadcasting service subscriber. In addition, the IPTV broadcasting service subscriber receiving the entitlement can watch the corresponding broadcast by using the received entitlement.

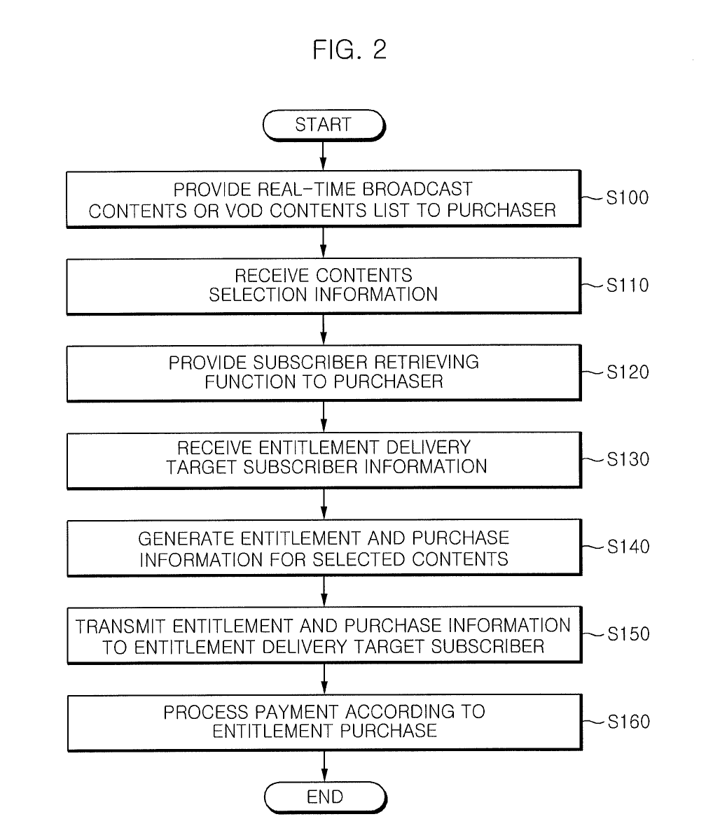

FIG. 2 is a diagram for describing a method for purchase and delivery of entitlement in an apparatus for purchase and delivery of entitlement according to an exemplary embodiment of the present invention.

Referring to FIG. 2, first, the apparatus for purchase and delivery of entitlement configures a charged broadcast contents list by using charged broadcast contents stored in a real-time broadcast contents DB and a VOD contents DB and provides it to a purchaser (S100).

In addition, any one content (delivery target content) is selected from the charged broadcast contents list by the purchaser (S110).

Next, the IPTV broadcasting service subscriber list (IPTV subscriber list) is configured by IPTV broadcasting service subscriber information stored in an IPTV subscriber DB and provided to the purchaser or a method to retrieve an IPTV subscriber is provided, and a target IPTV subscriber (entitlement delivery target subscriber) to which the entitlement for the deliver target contents will be delivered is selected by the purchaser (S120). In this case, the entitlement purchase environment provider 140 may use the e-mail address, telephone number, ID, nickname, etc., of the IPTV broadcasting service subscriber stored in the IPTV subscriber DB at the time of providing the IPTV subscriber list or the subscriber retrieving method to the purchaser. In this case, it is preferable to adopt a policy capable of solving a problem of leaking personal information.

Next, a receivable period, a receivable number of times, an entitlement scope, and a delivery message for the delivery target contents are received from the purchaser.

Next, the entitlement for the corresponding broadcast contents is generated by using information on the delivery target contents and purchase information is generated by using the information inputted from the purchaser at step S130 (S140). More specifically, a CAS module related to decoding the corresponding broadcast contents is generated by using information (i.e., contents identification information) on the delivery target contents selected at step S110. Herein, the CAS module may be installed and driven in the IPTV broadcasting service system adopting the downloadable conditional access system (DCAS) and processes an entitlement management message (EMM) and an entitlement control message (ECM) delivered by being included in an MPEG2-TS type stream and decodes (descrambles) the corresponding broadcast contents stream. In addition, the purchase information is generated so as for an IPTV broadcasting service provider acquiring the entitlement for the delivery target contents to verify the entitlement scope and the purchaser information on the basis of the receivable period, the receivable number of times, the entitlement scope, and the delivery message for the delivery target contents.

Next, the entitlement for the delivery target contents is delivered to an IPTV settop box of the entitlement delivery target subscriber on the basis of information on the entitlement delivery target subscriber selected at step S120 (S150).

When the entitlement for the delivery target contents is successfully delivered to the IPTV settop box of the entitlement delivery target subscriber at step S150, the payment according to the entitlement purchase is processed and the process is terminated (S160).

Accordingly, since the entitlement is purchased by an entitlement purchaser in addition to a voluntary service subscriber, consumption of the IPTV broadcast contents are activated for an IPTV broadcasting service provider.

Further, when the system, as a promotional means of an enterprise, is utilized as methods of providing the entitlement to a predetermined group which is a promotional target, inserting a predetermined enterprise advertisement into the corresponding broadcast contents, etc., the system can promote purchasing of the IPTV broadcast contents and increase a promotional effect of the corresponding enterprise.

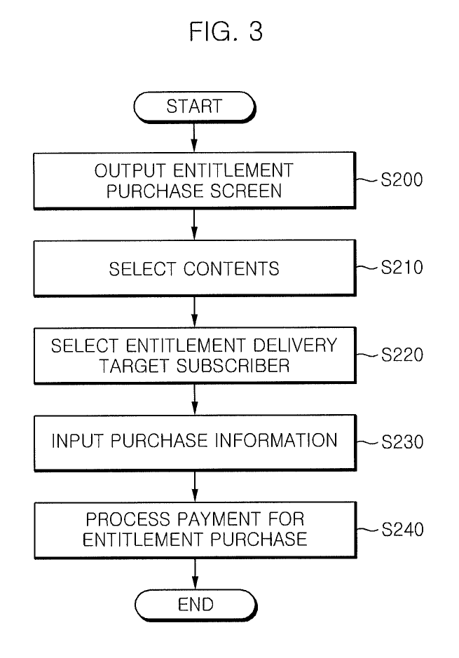

FIG. 3 is a diagram for describing a method for purchasing entitlement according to an exemplary embodiment of the present invention.

First, the entitlement purchasing method according to the exemplary embodiment of the present invention may be performed in an IPTV settop box of an IPTV broadcasting subscriber or a web-browser terminal of an IPTV broadcasting service non-subscriber. Hereinafter, an entitlement purchase service flow in an IPTV settop box will be described as an example.

Referring to FIG. 3, the IPTV settop box outputs an entitlement purchase screen through a display apparatus (i.e., a digital TV) (S200). That is, the IPTV settop box outputs the charged broadcast contents list and the IPTV broadcasting service subscriber list through the display apparatus.

In addition, in the IPTV settop box, one or more entitlement delivery target subscribers to which the delivery target contents and the entitlement for the delivery target contents will be delivered are selected by the purchaser through an input apparatus (i.e., a remote controller) (S210 and S220).

Next, a receivable period, a receivable number of times, an entitlement scope, and a delivery message for the delivery target contents are received from the purchaser through the input apparatus in the IPTV settop box (S230).

Lastly, when step S230 is terminated, and the entitlement and purchase information for the delivery target contents are successfully delivered to the entitlement delivery target subscriber, the payment for the entitlement purchase is processed (S240).

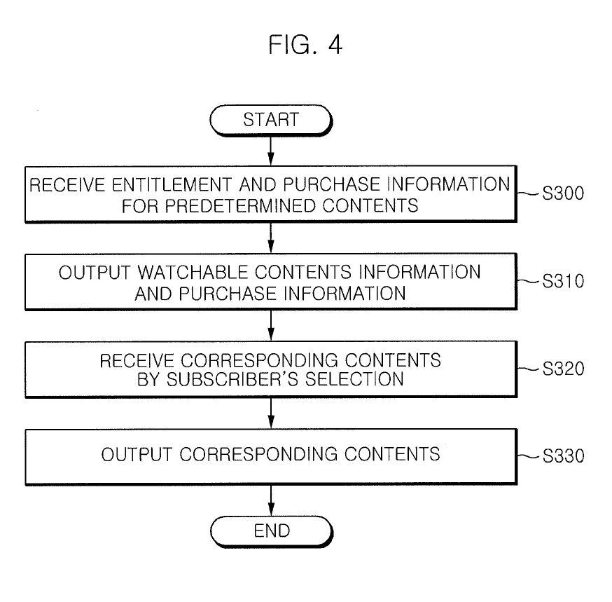

FIG. 4 is a diagram for describing a method for receiving entitlement according to an exemplary embodiment of the present invention.

Referring to FIG. 4, the IPTV settop box receives the entitlement and purchase information for predetermined contents from a headend system (S300).

When the entitlement and purchase information for the predetermined broadcast contents are received through step S300, watchable contents information (e.g., a title, a content, a genre, etc.) and purchase information are outputted to the corresponding user (IPTV broadcasting service subscriber) (S310).

Therefore, when the corresponding user desires to watch the corresponding broadcast contents, the corresponding user receives the corresponding broadcast contents stream, decodes the corresponding broadcast contents stream by using CAS included in the entitlement received at step S300, and outputs the decoded stream through the display apparatus (S330).

As described above, the IPTV broadcasting service subscriber can acquire a chance to watch broadcast contents other than the broadcast contents purchased by himself/herself and share predetermined broadcast contents preferred by a service user (purchaser) with another IPTV broadcasting service subscriber in a safe and legal method.

Some steps of the present invention can be implemented as a computer-readable code in a computer-readable recording medium. The computer-readable recording media includes all types of recording apparatuses in which data that can be read by a computer system is stored. Examples of the computer-readable recording media include a ROM, a RAM, a CD-ROM, a CD-RW, a magnetic tape, a floppy disk, an HDD, an optical disk, a magneto-optical storage device, etc., and in addition, include a recording medium implemented in the form of a carrier wave (for example, transmission through the Internet). Further, the computer-readable recording media are distributed on computer systems connected through the network, and thus the computer-readable recording media may be stored and executed as the computer-readable code by a distribution scheme.

As described above, the preferred embodiments have been described and illustrated in the drawings and the description. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. An apparatus for purchase and delivery of entitlement in an IPTV broadcast system, comprising:
an entitlement purchase environment provider providing a charged broadcast contents list to the purchaser so that the purchaser can select delivery target contents and providing an IPTV broadcasting service subscriber list to the purchaser so that the purchaser can select one or more entitlement delivery target subscribers to which the entitlement for the delivery target contents is delivered;
an entitlement generator receiving information on the delivery target contents from the entitlement purchase environment provider, and then generating the entitlement for corresponding broadcast contents; and
an entitlement transmitter delivering the entitlement for the delivery target contents to IPTV settop boxes of the entitlement delivery target subscribers on the basis of information on the entitlement delivery target subscribers.

2. The apparatus for purchase and delivery of entitlement in an IPTV broadcast system according to claim 1, wherein the entitlement purchase environment provider further receives at least one received information of a receivable period, a receivable number of times, an entitlement scope, and a delivery message of the delivery target contents from the purchaser, and
the entitlement generator generates purchase information on the basis the received information to process the purchase information to be delivered to the IPTV settop box of the delivery target subscriber in addition to the entitlement for the delivery target contents.

3. The apparatus for purchase and delivery of entitlement in an IPTV broadcast system according to claim 2, wherein the purchaser is an IPTV broadcasting service subscriber or an IPTV broadcasting service non-subscriber.

4. The apparatus for purchase and delivery of entitlement in an IPTV broadcast system according to claim 2, wherein the entitlement generator generates the purchase information by using information on an corresponding IPTV broadcasting service subscriber stored in an IPTV subscriber database and the received information when the purchaser is an IPTV broadcasting service subscriber.

5. The apparatus for purchase and delivery of entitlement in an IPTV broadcast system according to claim 1, wherein the entitlement transmitter delivers the entitlement for the delivery target contents to the IPTV settop boxes of the entitlement delivery target subscribers by using an out of band (OOB) channel.

6. The apparatus for purchase and delivery of entitlement in an IPTV broadcast system according to claim 1, wherein the entitlement purchase environment provider uses at least one of an e-mail address, a telephone number, an ID, and a nickname of an IPTV broadcasting service subscriber stored in an IPTV subscriber database at the time of providing the IPTV broadcasting service subscriber list to the purchaser.

7. The apparatus for purchase and delivery of entitlement in an IPTV broadcast system according to claim 1, wherein the entitlement includes a CAS module for decoding a corresponding broadcast contents stream.

8. The apparatus for purchase and delivery of entitlement in an IPTV broadcast system according to claim 7, wherein the CAS module processes an entitlement management message (EMM) and an entitlement control message (ECM) transmitted by being included in the corresponding broadcast contents stream.

9. An IPTV settop box in an IPTV broadcast system, comprising:
an entitlement purchase processor providing a user interface for allowing a purchaser to select a delivery target contents and one or more entitlement delivery target subscribers to which an entitlement for the delivery target contents is delivered; and
an entitlement receiver receiving the entitlement for predetermined broadcast contents purchased by a predetermined purchaser from a headend system.

10. The IPTV settop box according to claim 9, wherein the entitlement receiver further receives purchase information including at least one received information of a receivable period, a receivable number of times, an entitlement scope, and a delivery message of the predetermined broadcast contents from the headend system.

11. The IPTV settop box according to claim 10, wherein the entitlement includes a CAS module for decoding a predetermined broadcast contents stream.

12. A method for purchase and delivery of entitlement in an IPTV broadcast system, comprising:
selecting delivery target contents by providing a charged broadcast contents list to a purchaser;
selecting one or more entitlement delivery target subscribers to which the entitlement for the delivery target contents is delivered by providing an IPTV broadcasting service subscriber list to the purchaser;
generating the entitlement for the delivery target contents; and
delivering the entitlement for the delivery target contents to IPTV settop boxes of the entitlement delivery target subscribers on the basis of information on the entitlement delivery target subscribers.

13. The method for purchase and delivery of entitlement according to claim 12, further comprising:
further receiving at least one received information of a receivable period, a receivable number of times, an entitlement scope, and a delivery message of the delivery target contents from the purchaser; and
generating purchase information on the basis the received information to process the purchase information to be delivered to the IPTV settop boxes of the delivery target subscribers in addition to the entitlement for the delivery target contents.

14. The method for purchase and delivery of entitlement according to claim 13, wherein the generating of the purchase information on the basis the received information generates the purchase information by using information on an corresponding IPTV broadcasting service subscriber stored in an IPTV subscriber database and the received information when the purchaser is the IPTV broadcasting service subscriber.

15. The method for purchase and delivery of entitlement according to claim 12, wherein the delivering of the entitlement for the delivery target contents to the IPTV settop box of the entitlement delivery target subscribers delivers the entitlement for the delivery target contents to the IPTV settop boxes of the entitlement delivery target subscribers by using an out of band (OOB) channel.

16. The method for purchase and delivery of entitlement according to claim 12, wherein the providing of the charged broadcast contents list to the purchaser uses at least one of an e-mail address, a telephone number, an ID, and a nickname of an IPTV broadcasting service subscriber stored in an IPTV subscriber database at the time of providing the IPTV broadcasting service subscriber list to the purchaser.

17. The method for purchase and delivery of entitlement according to claim 12, wherein the entitlement includes a CAS module for decoding a corresponding broadcast contents stream.

18. The method for purchase and delivery of entitlement according to claim of 17, wherein the CAS module processes an entitlement management message (EMM) and an entitlement control message (ECM) transmitted by being included in the corresponding broadcast contents stream.

19. The method for purchase and delivery of entitlement according to claim 12, further comprising processing a payment according to a entitlement purchase when the entitlement is successfully delivered to the IPTV settop boxes of the entitlement delivery target subscribers.
